(19) United States
(12) Patent Application Publication
(10) Pub. No.: US 2018/0039473 A1
(43) Pub. Date: Feb. 8, 2018

(54) METHOD FOR PROVIDING GRAPHIC USER INTERFACE BASED ON DEGREE OF PARTICIPATION AND APPARATUS THEREOF

(71) Applicant: SAMSUNG SDS CO., LTD., Seoul (KR)

(72) Inventors: Bo Mi KIM, Seoul (KR); Hwa Shin LEE, Seoul (KR); Hyeon Cheol HWANG, Seoul (KR); Haa Nee NAM, Seoul (KR); Jin Ju YANG, Seoul (KR)

(73) Assignee: SAMSUNG SDS CO., LTD., Seoul (KR)

(21) Appl. No.: 15/666,787

(22) Filed: Aug. 2, 2017

(30) Foreign Application Priority Data
Aug. 3, 2016 (KR) 10-2016-0099041

(51) Int. Cl. G06F 3/14; G06F 3/0484

(52) U.S. Cl. CPC G06F 3/1454; G06F 3/04845; G06F 3/0482

(57) ABSTRACT

Provided are a service providing method performed by a service providing apparatus, the method comprises creating a conference session with a plurality of user terminals, generating a graphic user interface (GUI) that displays an object corresponding to each user terminal of the plurality of user terminals in a first area and displays conference content in a second area and providing the generated GUI to teach user terminal maintaining the conference session, wherein display attributes of the object are changed based on a conference participation grade of a corresponding user terminal.

This application claims the benefit of Korean Patent Application No. 10-2016-0099041, filed on Aug. 3, 2016, in the Korean Intellectual Property Office, the disclosure of which is incorporated herein by reference in its entirety.

### BACKGROUND

### 1. Field

The present inventive concept relates to a method and apparatus for providing a service based on the degree of participation, and more particularly, to a method and apparatus for providing various graphic effects according to the degree of conversion participation of an online attendee in an environment where a communication application between a plurality of people is provided.

### 2. Description of the Related Art

Interactive services that enable a plurality of users located in different spaces to exchange messages are being provided. Typical examples of interactive services include an instant messaging service and a real-time conference service provided to a plurality of user terminals.

Such services provide convenience in exchanging messages among users at remote locations. However, since users are engaged in conversation through their terminals in separate spaces, they are less immersed in conversation. For example, users participating in a real-time conference may not be able to concentrate on the conference by performing personal tasks through their respective terminals. In addition, a presenter or speaker of the conference may not be able to judge the degrees of participation and concentration of the online attendees. This reduces the efficiency of the real-time conference.

Nevertheless, the conventional real-time conference service simply provides information about participants' log-in status and information about a speaker. That is, there is no method of providing a graphic user interface (GUI) that offers an environment similar to an offline conference to online attendees and changes the display position of an object representing each of the online attendees based on the degree of conversation participation.

### SUMMARY

Aspects of the inventive concept provide a method and apparatus for providing a graphic user interface (GUI) which can intuitively display the degree of conference participation of an online attendee.

Specifically, aspects of the inventive concept provide a GUI which generates a virtual conference space having a structure similar to that of an offline conference and displays a plurality of online attendees in the virtual conference space.

Aspects of the inventive concept also provide a method and apparatus for measuring the degree of participation of an online attendee connected to a real-time conference service.

Aspects of the inventive concept also provide a method and apparatus for providing a GUI which changes display attributes of an avatar of an online attendee connected to a real-time conference service based on the measured degree of participation.

However, aspects of the inventive concept are not restricted to the one set forth herein. The above and other aspects of the inventive concept will become more apparent to one of ordinary skill in the art to which the inventive concept pertains by referencing the detailed description of the inventive concept given below.

According to an aspect of the inventive concept, there is provided a service providing method performed by a service providing apparatus, the method comprises creating a conference session with a plurality of user terminals, generating a graphic user interface (GUI) that displays an object corresponding to each user terminal of the plurality of user terminals in a first area and displays conference content in a second area, and providing the generated GUI to teach user terminal maintaining the conference session, wherein display attributes of the object are changed based on a conference participation grade of a corresponding user terminal.

According to another aspect of the inventive concept, there is provided a service providing method performed by a service providing apparatus, the method comprises creating an instant messaging session with a plurality of user terminals, providing a first GUI to the plurality of user terminals with which the instant messaging session was created, for a first preset period, determining a participation grade of each user terminal based on at least from among a size and a number of messages received through the first GUI for the first period, generating a second GUI, in which display attributes of an object corresponding to each user terminal have been changed, based on the determined participation grade; and providing the generated second GUI to each user terminal maintaining the instant messaging session for a second preset period.

According to another aspect of the inventive concept, there is provided an object displaying method performed by a user terminal, the method creating a conference session with a service providing apparatus, receiving a GUI from the service providing apparatus, which displays an object corresponding to a user terminal in a first area and conference content in a second area, receiving conference attendee content from a user and changing display attributes of the object in the first area based on a participation grade determined by the service providing apparatus in response to the receiving of the conference attendee content, and displaying the changed display attributes.

### BRIEF DESCRIPTION OF THE DRAWINGS

These and/or other aspects will become apparent and more readily appreciated from the following description of the embodiments, taken in conjunction with the accompanying drawings in which:

FIG. 1 illustrates the configuration of a service providing system according to an embodiment;

FIG. 2 is a block diagram of a service providing apparatus according to an embodiment;

FIG. 3 is a flowchart illustrating a method of providing a graphic user interface (GUI) according to an embodiment;

FIG. 4 is a flowchart illustrating a method of changing the positions of objects on a GUI according to embodiments;

FIG. 5 is a flowchart illustrating a method of changing display attributes of an object on a GUI according to embodiments;

FIG. 6 illustrates an example GUI which is referred to in some embodiments;

FIGS. 7 and 8 illustrate methods of arranging objects, which are referred to in some embodiments;

FIG. 9 is a table for explaining a method of determining a participation grade according to an embodiment;

FIG. 10 illustrates display attributes of an object according to a participation grade, which are referred to in some embodiments;

FIG. 11 illustrates a change in the display state of an object according to a change in participation grade, which is referred to in some embodiments;

FIG. 12 illustrates a change in the display position of an object according to a change in participation grade, which is referred to in some embodiments;

FIG. 13 illustrates a method of displaying an object of a user terminal whose session connection has been terminated, which is referred to in some embodiments;

FIG. 14 is a flowchart illustrating a method of displaying an object of a user terminal according to an embodiment;

FIG. 15 illustrates a condition under which a user terminal changes display attributes of an object, which is referred to in some embodiments;

FIG. 16 is a block diagram of a user terminal according to an embodiment; and

FIG. 17 illustrates a method of displaying an object according to a participation grade in an instant messaging environment according to an embodiment.

### DETAILED DESCRIPTION

Hereinafter, preferred embodiments of the present invention will be described with reference to the attached drawings. Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like numbers refer to like elements throughout.

Unless otherwise defined, all terms including technical and scientific terms used herein have the same meaning as commonly understood by one of ordinary skill in the art to which this invention belongs. Further, it will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terms used herein are for the purpose of describing particular embodiments only and is not intended to be limiting. As used herein, the singular forms are intended to include the plural forms as well, unless the context clearly indicates otherwise.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

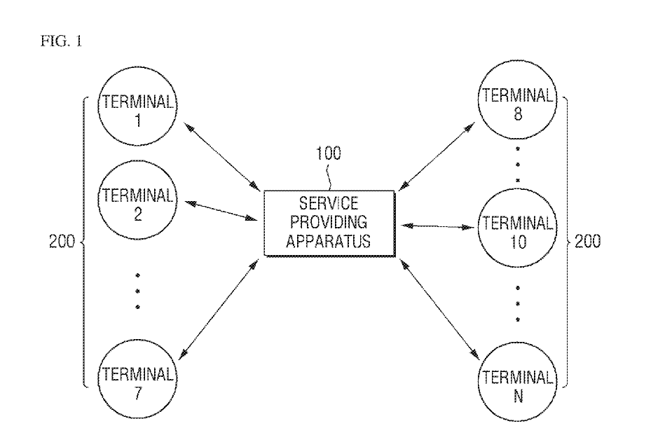

FIG. 1 illustrates the configuration of a service providing system according to an embodiment.

Referring to FIG. 1, the service providing system may include a service providing apparatus 100 and a plurality of user terminals 200. In particular, terminal 1, terminal 2, terminal 7, terminal 8, terminal 10 and terminal N are illustrated in FIG. 1 as an example of the user terminals 200. The service providing system may include more user terminals 200 or less user terminals 200 connecting to the service providing apparatus 100. That is, the number of the user terminals 200 is not limited to the example illustrated in FIG. 1.

The service providing apparatus 100 is a computing apparatus capable of communicating with the user terminals 200 of FIG. 1 through a network. The service providing apparatus 100 may be a server that provides a real-time conference service to the user terminals 200. Alternatively, the service providing apparatus 100 may be a server that provides an instant messaging service between the user terminals 200. Here, the network through which the service providing apparatus 100 communicates with the user terminals 200 may consist of one or more of various networks such as the Internet and an intranet.

The service providing apparatus 100 can detect the connection of a user terminal 200. The service providing apparatus 100 may receive unique information of a connected user terminal 200 from the connected user terminal 200. For example, the unique information may include at least one of a network Internet protocol (IP) of the user terminal 200, a media access control (MAC) address of the user terminal 200, an international mobile equipment identity (IMEI) of the user terminal 200, location information of the user terminal 200, and log-in information of a user. Alternatively, the service providing apparatus 100 may detect the connection of the user terminal 200 when receiving a service request through the web from the user terminal 200 together with at least one piece of the unique information.

The service providing apparatus 100 may detect the connection of a user terminal 200 and create a communication session with the user terminal 200 according to a service provided by the service providing apparatus 100. In this case, the service providing apparatus 100 may provide various interfaces to the user terminal 200 so that the user terminal 200 can use the service. The service providing apparatus 100 may create the communication session only when the user terminal 200 is identified as a terminal of a service target person registered in advance. To this end, the service providing apparatus 100 may receive and store information about the user terminal 200 in advance. Here, the information about the user terminal 200 may include at least one of the above unique information and user information matched with the unique information.

In particular, in this specification, a case where the service providing apparatus 100 provides a graphic user interface (GUI) will be mainly described.

Each of the user terminals 200 illustrated in FIG. 1 may be a fixed or mobile computing device. For example, each of the user terminals 200 may be any one of a desktop PC, a laptop, a smart phone, and a PDA.

According to an embodiment, the service providing apparatus 100 and each of the user terminals 200 may form a server-client relationship. That is, when the service providing apparatus 100 serves as a server that provides a real-time conference service or an instant messaging service to the user terminals 200, the user terminals 200 may serve as clients that request the service and transmit responses to the provided service.

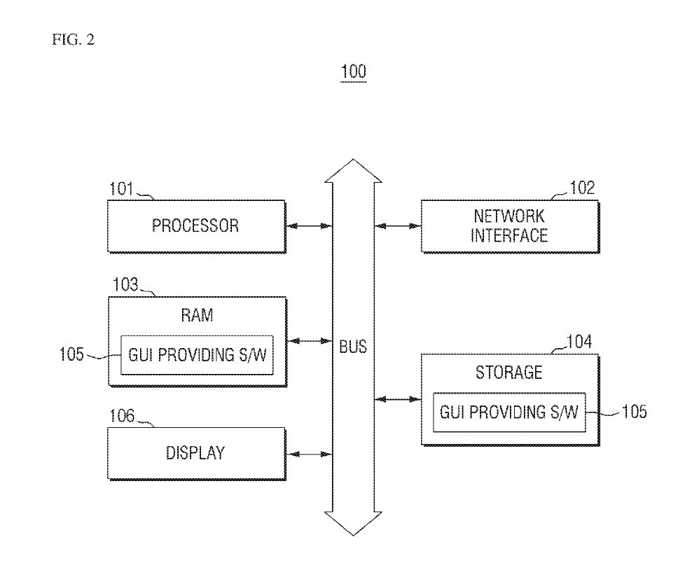

FIG. 2 is a block diagram of a service providing apparatus 100 according to an embodiment.

The structure and operation of the service providing apparatus 100 will now be described in detail with reference to FIG. 2.

Referring to FIG. 2, the service providing apparatus 100 may include one or more processors 101, a network interface 102 which communicates with a plurality of terminals, a memory 103 which loads a computer program to be executed by the processors 101, a storage 104 which stores the computer program, and a display 106.

The processors 101 control the overall operation of each component of the service providing apparatus 100. The processors 101 may include a central processing unit (CPU), a micro-processor unit (MPU), a micro-controller unit (MCU), or any type of processor well known in the art to which the inventive concept pertains. In addition, the processors 101 may perform an operation on at least one application or program for executing a method according to embodiments. The service providing apparatus 100 may include one or more processors.

The network interface 102 supports wired/wireless Internet communication of the service providing apparatus 100. In addition, the network interface 102 may support various communication methods other than Internet communication. To this end, the network interface 102 may include a communication module well known in the art to which the inventive concept pertains.

The network interface 102 may transmit data to or receive data from the user terminals 200 of FIG. 1 through the network. In particular, the network interface 102 may provide the user terminals 200 with a GUI for using a service provided by the service providing apparatus 100. In addition, the network interface 102 may receive attendee content from the user terminals 200. The attendee content includes voice content, image content, and text content. The network interface 102 may also receive action feedback according to an embodiment. The action feedback is a signal generated by a user terminal 200. The action feedback may be signals generated by a user's various inputs related to a service provided by the service providing apparatus 100, such as the user's request for remarks, bookmarking of conference content, typing text, agreement, and recommendation.

The memory 103 stores various data, commands and/or information. The memory 103 may load one or more programs 105 from the storage 104 to execute a service providing method according to embodiments. In FIG. 2, a random access memory (RAM) is illustrated as an example of the memory 103.

The storage 104 may non-temporarily store the programs 105. In FIG. 2, GUI providing software 105 is illustrated as an example of the programs 105.

The storage 104 may include a nonvolatile memory such as a read only memory (ROM), an erasable programmable ROM (EPROM), an electrically erasable programmable ROM (EEPROM) or a flash memory, a hard disk, a removable disk, or any type of computer-readable recording medium well known in the art to which the inventive concept pertains.

The GUI providing software 105 is executed by the processors 101 so that the service providing apparatus 100 can provide a GUI to a plurality of user terminals 200 according to an embodiment.

The display 106 may display a GUI that the service providing device 100 provides to the user terminals 200. Thus, a user of the service providing apparatus 100 can check the GUI that is displayed on the user terminals 200. The display 106 is not an essential component of the service providing apparatus 100. According to an embodiment, the service providing apparatus 100 may not include the display 106.

Although not illustrated, the service providing apparatus 100 may further include an input unit for receiving various settings related to a service provided by the service providing apparatus 100.

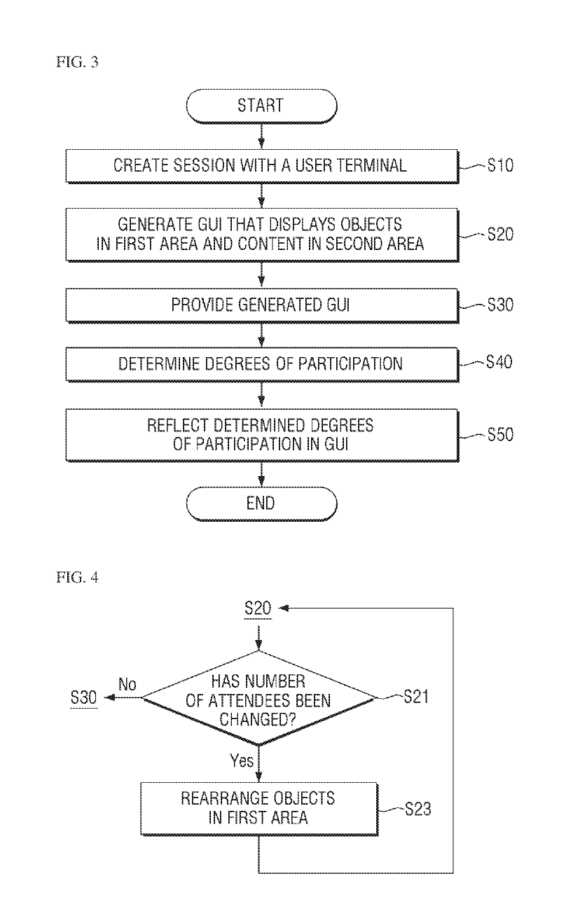

FIG. 3 is a flowchart illustrating a service providing method according to an embodiment.

It will hereinafter be assumed that each operation included in the service providing method is performed by the service providing apparatus 100. In particular, the service providing method is performed as the processors 101 execute operations according to the GUI providing software 105.

A case where the service providing apparatus 100 provides a real-time conference service to a plurality of user terminals 200 will be described below as an example.

Referring to FIG. 3, the service providing apparatus 100 may create a conference session with a plurality of user terminals 200 (operation S10). In particular, in operation S10, the service providing apparatus 100 may transmit a conference session creation request to a preset number of user terminals 200. When receiving a response to the conference session creation request from one or more of the user terminals 200, the service providing apparatus 100 may create a conference session with the user terminals 200.

After creating the conference session, the service providing apparatus 100 may generate a GUI which displays an object corresponding to each of the user terminals 200 in a first area and displays conference content in a second area (operation S20). Here, the first area and the second area are areas included in a real-time conference service screen provided by the service providing apparatus 100 to the user terminals 200. The first area and the second area may be different areas. For example, the second area may be an area located at the center of the service screen, and the first area may be an outer area surrounding the second area.

In addition, the object may be, for example, an icon representing a user of each of the user terminals 200 or a user avatar. The object may include all or part of the user's ID, a user-set image, and the like.

The conference content is content used in a conference and may be either a conference-related material, such as a document or image being described by a speaker, or image content of the speaker. The conference content may be content pre-stored in the storage 104 of the service providing apparatus 100. Alternatively, the conference content may be content received through the network interface 102.

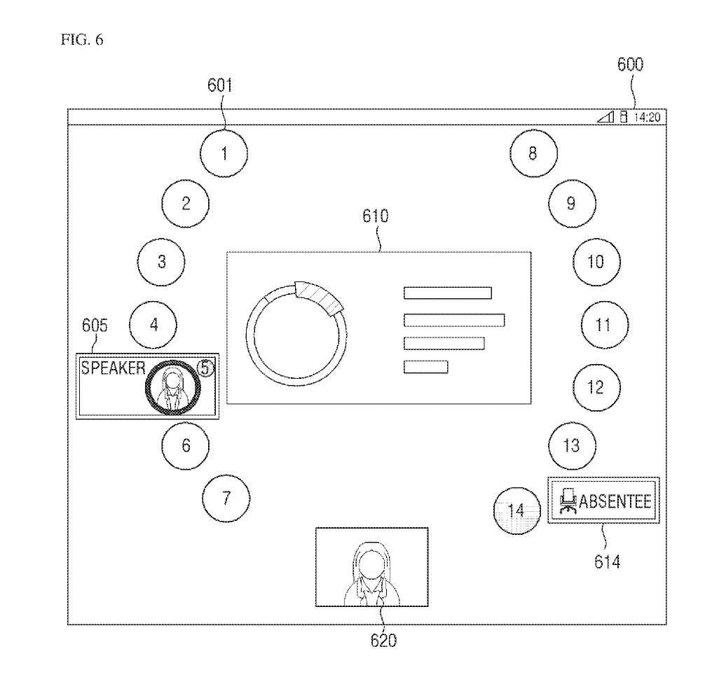

Next, the service providing apparatus 100 may provide the generated GUI to the user terminals 200 maintaining the conference session (operation S30). The generated GUI and the service screen will be described later with reference to FIG. 6.

After providing the generated GUI, the service providing apparatus 100 may receive attendee content from each of the user terminals 200 through the GUI. Based on the received attendee content, the service providing apparatus 100 may determine a conference participation grade of each of the user terminals 200 (operation S40). The service providing apparatus 100 can determine the conference participation grade of each user terminal 200 by quantitatively and/or qualitatively analyzing the degree of participation of each user terminal 200. For example, the service providing apparatus 100 may determine the participation grade of a user terminal 200 by analyzing at least one of the data size of voice content transmitted from the user terminal 200, the number of times the voice content was transmitted, and the playback time of the voice content. The service providing apparatus 100 may also determine the participation grade of the user terminal 200 by analyzing at least one of the continuity of the received voice content and the time intervals at which the voice content was received.

In an embodiment, the service providing device 100 may determine the participation grade of each user terminal 200 based on the conference content provided in the second area of the generated GUI. That is, for example, when the conference content requires the expression of assent or dissent to one or more agendas, the service providing apparatus 100 may determine the participation grade of a user terminal 200 based on whether a message including assent or dissent is received from the user terminal 200. In addition, when the conference content is a questionnaire composed of a plurality of questions, the service providing apparatus 100 may determine the participation grade of a user terminal 200 according to whether a response message for a preset number or more of the questions is received from the user terminal 200.

The service providing apparatus 100 may reflect the determined participation grades in the GUI (operation S50).

That is, the service providing apparatus 100 may change display attributes of the GUI being provided to the user terminals 200 based on the determined participation grades. In particular, the service providing apparatus 100 may change display attributes of the objects displayed in the first area. For example, when the determined participation grade of a user terminal 200 is low, the service providing apparatus 100 may move the display position of an object corresponding to the user terminal 200 away from the second area where the conference content is displayed.

In addition, the service providing apparatus 100 may determine access rights of the user terminals 200 to a menu on the GUI based on the determined participation grades of the user terminals 200. For example, the service providing apparatus 100 may authorize a user terminal 200 having a high participation grade to access a menu for changing the type of the conference content displayed in the second area. In a case where the conference content is a document, the service providing apparatus 100 may authorize a user terminal 200 having a participation grade higher than a preset grade to access a page different from a page currently indicated by a speaker in the conference. Alternatively, the service providing apparatus 100 may authorize a user terminal 200 having a participation grade higher than the preset grade to change the type of the conference content displayed on the user terminal 200.

On the other hand, the service providing apparatus 100 may restrict the access of a user terminal 200 having a low participation grade to the menu for changing the type of the conference content displayed in the second area. That is, the service providing apparatus 100 may restrict the access of a user terminal 200 having a participation grade lower than the preset grade to the menu for changing the type of the conference content displayed in the second area. A case where the conference content being displayed requires the expression of assent or dissent to a specific agenda will now be described as an example.

When a user terminal 200 does not transmit a message including assent or dissent, the service providing apparatus 100 may give a low participation grade to the user terminal 200. For example, the participation grade of the user terminal 200 may be determined to be grade 0. To a user terminal 200 that has transmitted a message including assent or dissent, the service providing apparatus 100 may give grade 1 as a participation grade.

In this case, the service providing apparatus 100 may provide content different from the above agenda only to user terminals 200 of grade 1 or higher as the conference content. Alternatively, the service providing apparatus 100 may grant the authority to change the conference content to the different content only to the user terminals 200 of grade 1 or higher. On the other hand, the service providing apparatus 100 may restrict the access of user terminals 200 of grade 0 to the different content unless a message for the above agenda is received from the user terminals 200 of grade 0. In this case, the user terminals 200 may display only the conference content about the above agenda on the second area of the GUI.

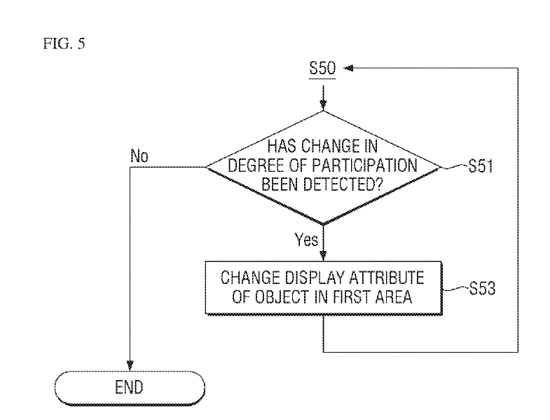

FIG. 4 is a flowchart illustrating a method of changing the positions of objects on a GUI according to embodiments.

Referring to FIG. 4, in operation S20, the service providing apparatus 100 may determine whether the number of user terminals attending the conference has been changed (operation S21). For example, when a session with any one of the user terminals 200 is terminated or when a new session is created with a new terminal 200, the service providing apparatus 100 may detect this change and detect the number of user terminals 200 attending the conference based on the detected change. In addition, the service providing apparatus 100 may determine whether the number of user terminals 200 maintaining the session has been changed based on the detected number of user terminals 200.

When the number of user terminals 200 with which the conference session was created is changed, the service providing apparatus 100 may rearrange the objects displayed on the first area of the GUI (operation S23). For example, the service providing apparatus 100 may generate a GUI in which at least one display attribute selected from object position in the first area and object size has been changed.

When determining in operation S21 that there is no change in the number of user terminals 200 maintaining the session, the service providing apparatus 100 performs operation S30.

FIG. 5 is a flowchart illustrating a method of changing display attributes of an object on a GUI according to embodiments.

Referring to FIG. 5, in operation S50, the service providing apparatus 100 can change display attributes of a GUI being provided to a user terminal 200 based on a determined participation grade of the user terminal 200. The service providing apparatus 100 can also update the participation grade of the user terminal 200 determined in operation S40 based on conference attendee content received after the participation grade was determined. The service providing apparatus 100 may determine whether the conference participation grade of the user terminal 200 has been changed according to the update (operation S51). When determining that the participation grade of the user terminal 200 has been changed, the service providing apparatus 100 may change display attributes of an object corresponding to the user terminal 200 (operation S53). Then, the service providing apparatus 100 may reflect the changed display attributes of the object in the GUI (operation S50).

On the other hand, if the participation grade has not been changed in operation S51, the service providing apparatus 100 may continuously provide the user terminal 200 with the GUI that reflects the participation grade determined in operation S40.

FIG. 6 illustrates an example GUI which is referred to in some embodiments.

In FIG. 6, a service screen 600 is illustrated as an example of a GUI provided by the service providing apparatus 100 to user terminals 200. The service screen 600 may include a plurality of objects corresponding to the user terminals 200, respectively. Object 1 (601) through object 14 shown in FIG. 6 may be objects corresponding to a plurality of user terminals 200 expected to attend a conference. Terminal 1 of FIG. 1 may correspond to object 1 (601). The service screen 600 may include a first area where a plurality of objects are displayed and may display conference content 610 in a second area.

Referring to FIG. 6, in operation S20, the service providing apparatus 100 may generate a GUI in which the above objects are arranged along a preset path in the first area centered on a center point of the second area. In particular, in the GUI of FIG. 6, an invisible circle exists in the first area, and object 1 (601) through object 7 are arranged in a counterclockwise direction along the circumference of the circle. In addition, object 8 through object 14 are arranged in a clockwise direction by the service providing apparatus 100. The arranged objects can include a user image, like object 5.

Accordingly, the service providing apparatus 100 can visualize a situation where attendees are seated around a table in an actual offline conference.

In operation S20, the service providing apparatus 100 may receive voice content from any one of the user terminals 200 with which a conference session was created. In this case, the service providing apparatus 100 may generate a GUI in which an object corresponding to the any one of the user terminals 200 is displayed in a preset shape. That is, the service providing apparatus 100 may generate a GUI in which an object corresponding to a terminal of a speaker who is currently speaking at the conference has been marked. Also, the service providing apparatus 100 may provide the generated GUI to the user terminals 200 currently maintaining the conference session. In FIG. 6, the speaker is a user of terminal 5, and object 5 has been marked by the service providing apparatus 100.

In operation S20, the service providing apparatus 100 may also receive image content of a user from any one of the user terminals 200, in addition to the voice content. Here, the any one of the terminals 200 may be the terminal of the speaker. Also, the image content may be an image obtained in real time from the terminal of the speaker.

The service providing apparatus 100 may display the received image content in a third area. The third area may be an area that does not overlap the first area and the second area. In FIG. 6, the third area in which received image content 620 is displayed is a lower middle part of the service screen 600.

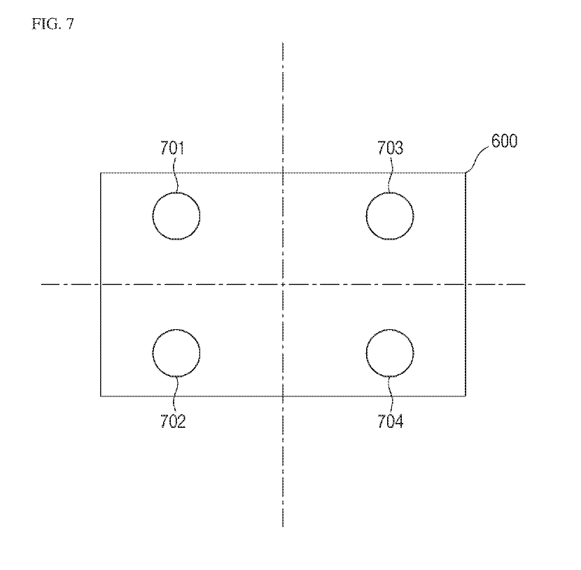

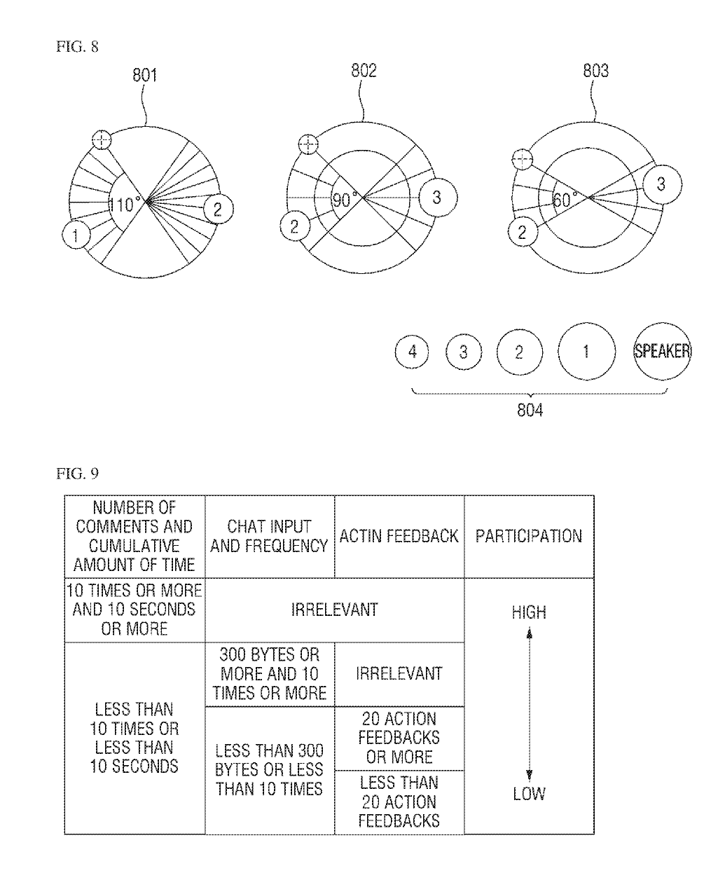

FIGS. 7 and 8 illustrate methods of arranging objects, which are referred to in some embodiments.

Referring to FIGS. 7 and 8, in operation S20, the service providing apparatus 100 may generate a GUI in which at least one display attribute selected from object position in the first area and object size has been changed based on the number of user terminals 200 with which a conference session was created.

Specifically, referring to FIG. 7, when a session is created with user terminals 200, the service providing apparatus 100 may sequentially place object 1 (701), object 2 (702), object 3 (703), and object 4 (704) on a service screen 600. In FIG. 7, the service providing apparatus 100 places one object in each quadrant of the service screen 600. Here, the size and position of each object can be changed as the number of user terminals 200 creating a conference session increases or decreases. For example, when the number of user terminals 200 creating a conference session increases, the GUI may be changed such that the distance between the objects and the size of each object are reduced. Conversely, when the number of user terminals 200 creating the conference session decreases, the GUI may be changed such that the distance between the objects and the size of each object are increased.

In FIG. 7, the service screen 600 is divided into four areas. However, the inventive concept is not limited to this embodiment. As the number of user terminals 200 creating a conference session increases, the way that the service screen 600 is divided may be changed.

Referring to FIG. 8, the service providing apparatus 100 may divide a service screen into areas, each occupied by a specific angle, based on the number of user terminals 200 which have created a conference session.

On a service screen 801, the service providing apparatus 100 places object 1 and object 2 in two areas, each having an angle of 110 degrees with respect to a preset reference point. When a user terminal 200 additionally creates a conference session, an area for placing objects may be divided into 90-degree areas as shown on a service screen 802. That is, the number of areas where objects are placed is increased. A service screen 803 shows a case where the number of user terminals 200 creating a conference session has increased compared with the service screen 802.

Referring to an example 804 of objects, the number inside each object in the example 804 denotes the total number of objects placed on a service screen. That is, an object having 4 indicates that the total number of objects is 4, and an object having 1 indicates that the total number of objects is 1. As apparent from the example 804, the size of an object placed decreases as the total number of objects increases. According to the example 804, an object of a speaker may be kept at a constant size.

FIG. 9 is a table for explaining a method of determining a participation grade according to an embodiment.

In FIG. 9, criteria for determining a conference participation grade in operation S40 are illustrated as an example. The service providing apparatus 100 may pre-store a table as the one illustrated in FIG. 9 to determine a conference participation grade of each user terminal 200 maintaining a conference session.

Referring to FIG. 9, the service providing apparatus 100 may receive attendee content from a user terminal 200 maintaining a conference session and determine a participation grade of the user terminal 200 based on the length of received voice content and/or the number of times the voice content was received. In addition, the service providing apparatus 100 may determine the participation grade of the user terminal 200 based on the amount of received text and/or the number of times the text was received.

The service providing apparatus 100 may identify the type of the attendee content when determining the conference participation grade of the user terminal 200. That is, the service providing apparatus 100 may identify whether the received attendee content is voice content, text content, image content, or action feedback. Also, the service providing apparatus 100 may give a preset weight to the identified type of the attendee content and determine the conference participation grade based on the weight given to the attendee content.

For example, when a highest weight is set for the voice content, an intermediate weight for the text content, and a lowest weight for the action feedback, the service providing apparatus 100 may determine a final participation grade by multiplying a weight given to the attendee content by the total number of times that each attendee content was received or the data size of the received attendee content.

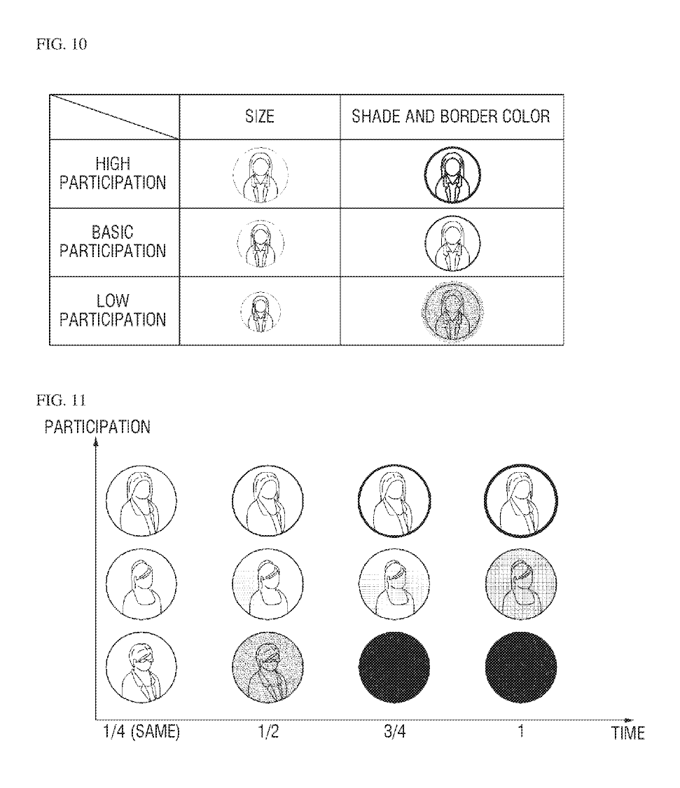

FIG. 10 illustrates display attributes of an object according to a participation grade, which are referred to in some embodiments.

In operation S20, the service providing apparatus 100 may generate a GUI in which at least one of the shape, color, and display brightness of an object has been changed based on a determined conference participation grade of a user terminal 200, so that the generated GUI can be displayed on the user terminal 200.

Referring to FIG. 10, the service providing apparatus 100 may adjust the display brightness of an object corresponding to a user terminal 200 according to a conference participation grade of the user terminal 200. The service providing apparatus 100 may generate a GUI to which the adjusted display brightness of the object has been applied and provide the generated GUI to the user terminal 200. For example, the service providing apparatus 100 may generate a GUI in which an object of a user terminal having a relatively high participation grade among user terminals 200 maintaining a conference session is displayed bright and an object of a user terminal having a low participation grade is displayed dark and provide the generated GUI to the user terminals 200.

Alternatively, the service providing apparatus 100 may adjust the size of an object corresponding to a user terminal 200 based on a conference participation grade of the user terminal 200. The service providing apparatus 100 may generate a GUI to which the adjusted size of the object has been applied and provide the generated GUI to the user terminal 200. For example, the service providing apparatus 100 may generate a GUI in which an object of a user terminal having a relatively high participation grade among user terminals 200 maintaining a conference session is displayed large and an object of a user terminal having a low participation grade is displayed small and provide the generated GUI to the user terminals 200.

The service providing apparatus 100 may compare a conference participation grade determined for a first terminal among the user terminals 200 and a conference participation grade determined for a second terminal in order to determine which of the first terminal and the second terminal has a relatively high or low participation grade.

In an embodiment, the service providing apparatus 100 may adjust the shape of an object corresponding to a user terminal 200 based on a conference participation grade of the user terminal 200. Referring to FIG. 10, the service providing apparatus 100 may add a border to an object of a user terminal having a high participation grade in order to emphasize the object or may blur an object of a user terminal having a low participation grade in order to restrain the user terminal. Accordingly, the object corresponding to the user terminal having the low participation grade is blurred in FIG. 10.

Although not illustrated, the service providing apparatus 100 may display an object in a preset color and/or shape according to a participation grade. For example, an object of a user terminal having a high participation grade may be displayed in a circular shape, and an object of a user terminal having a low participation grade may be displayed in a triangular shape.

FIG. 11 illustrates a change in the display state of an object according to a change in participation grade, which is referred to in some embodiments.

A GUI provided to user terminals 200 is continuous from the perspective of the user terminals 200. However, the GUI can be changed in various ways as described above with reference to FIG. 10. Referring to FIG. 11, the service providing apparatus 100 receives attendee content from each of the user terminals 200 for a first preset period. During the initial first period, respective objects of the user terminals 200 may be arranged in the same brightness, size, or shape on a service screen. The service providing apparatus 100 may determine a conference participation grade of each user terminal 200 based on the attendee content received during the first period. Then, the service providing apparatus 100 may generate a GUI in which display attributes of the objects of the user terminals 200 have been changed as illustrated in FIG. 11 based on the determined participation grades and provide the generated GUI to the user terminals 200 during a second preset period that is successive to the first period. In FIG. 11, an object of a user terminal having a high participation grade is highlighted over time, and an object of a user terminal having a low participation grade is blurred over time.

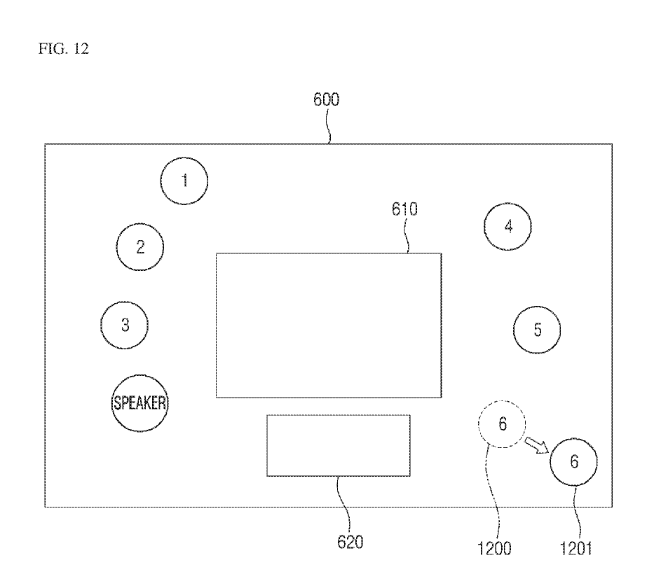

FIG. 12 illustrates a change in the display position of an object according to a change in participation grade, which is referred to in some embodiments.

In operation S20, the service providing apparatus 100 may compare a conference participation grade determined for a first terminal among user terminals 200 and a conference participation grade determined for a second terminal. In addition, the service providing apparatus 100 may change at least one of the display position of an object corresponding to the first terminal and the display position of an object corresponding to the second terminal based on the comparison result.

Specifically, the service providing apparatus 100 may place a terminal having a high conference participation grade closer to a center point of a second area in which conference content 610 is displayed than a terminal having a low conference participation grade or place the terminal having the low conference participation grade farther from the center point than the terminal having the high conference participation grade.

On a service screen 600 of FIG. 12, object 6 is moved away from the center of the second area in which the conference content 610 is displayed. That is, when the participation grade of user terminal 6 is relatively lowered, the service providing apparatus 100 may change the display position of object 6, which is an object of user terminal 6, from a first position 1200 to a second position 1201 which is farther from the center of the second area.

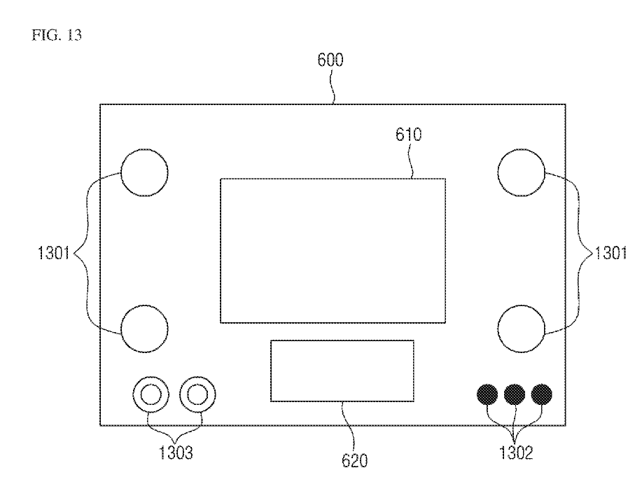

FIG. 13 illustrates a method of displaying an object of a user terminal whose session connection has been terminated, which is referred to in some embodiments.

In operation S10, the service providing apparatus 100 may transmit a conference session creation request to a preset number of user terminals 200. Here, the preset number of user terminals 200 may be user terminals expected to attend a conference and registered in advance in the service providing apparatus 100.

The service providing apparatus 100 may create a conference session with a user terminal which has responded to the conference session creation request among the user terminals 200. However, the service providing apparatus 100 cannot create a session with a user terminal which has not responded to the conference session creation request. The service providing apparatus 100 may generate a GUI that displays an object corresponding to a user terminal, with which a session was not created, at a preset position in the first area.

Referring to FIG. 13, on a service screen 600, the service providing apparatus 100 may place objects 1301 of user terminals with which a conference session was created and place objects 1302 of user terminals with which a conference session was not created at a different position from the objects 1301. At this time, the service providing apparatus 100 may also adjust display attributes of the objects 1301 and 1302 such that sizes and colors of the objects 1301 and 1302 are distinguished from each other.

Meanwhile, the service providing apparatus 100 may display objects 1303 of user terminals which have initially created a conference session but later terminated the conference session in a different position and/or shape from the objects 1301.

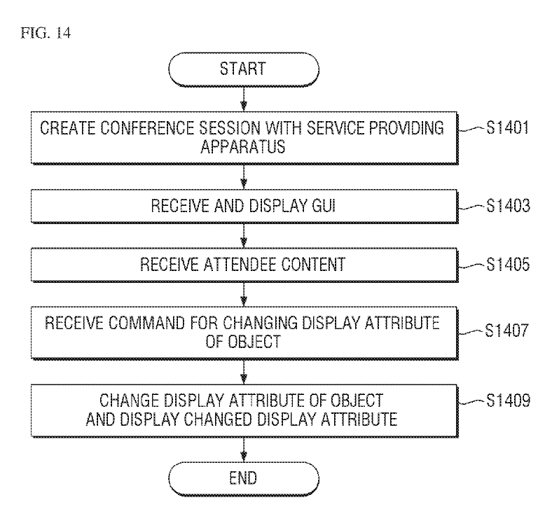

FIG. 14 is a flowchart illustrating a method of displaying an object of a user terminal according to an embodiment.

Referring to FIG. 14, a user terminal 200 may create a conference session with the service providing apparatus 100 (operation S1401). The user terminal 200 may transmit its unique information and a service request message to the service providing apparatus 100 through a network. The service providing apparatus 100 may receive the unique information and detect the connection of the user terminal 200 based on the received unique information. When the service providing apparatus 100 permits a service in response to the service request message of the user terminal 200, a session is created between the service providing apparatus 100 and the user terminal 200.

The user terminal 200 may receive a GUI from the service providing apparatus 100 and display the received GUI on an output unit (operation S1403). For example, the displayed GUI may be the service screen 600 illustrated in FIG. 6. That is, the user terminal 200 may display an object corresponding to the user terminal 200 in the first area and display conference content in the second area.

The user terminal 200 may receive conference attendee content through an input unit (operation S1405). The user terminal 200 may transmit the received attendee content to the service providing apparatus 100 through the session. The service providing apparatus 100 may analyze the received conference attendee content and determine a participation grade of the user terminal 200. At this time, the service providing apparatus 100 may determine a participation grade of the user terminal 200 for a first preset period based on the conference attendee content received during the first period.

The service providing apparatus 100 may transmit a command for changing display attributes of the object corresponding to the user terminal 200 based on the determined participation grade. Upon receiving the command for changing the display attributes of the object (operation S1407), the user terminal 200 may change the display attributes of the object in the first area and display the changed display attributes (operation S1409).

Specifically, in response to the command for changing the display attributes, the user terminal 200 may change at least one of the shape, color, display position, and display size of the object in the first area and display the object accordingly.

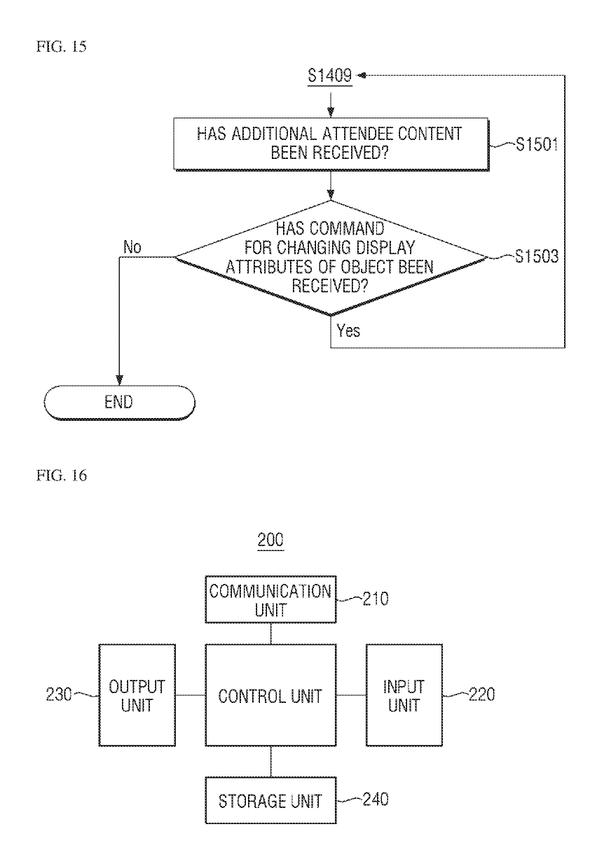

FIG. 15 illustrates a condition under which a user terminal changes display attributes of an object, which is referred to in some embodiments.

After operation S1409, the user terminal 200 may receive conference attendee content for a second preset period different from the first preset period (operation S1501). The user terminal 200 may transmit the conference attendee content received during the second preset period to the service providing apparatus 100. The service providing apparatus 100 may determine a participation grade of the user terminal 200 for the second period based on the conference attendee content received during the second period.

If the participation grade for the first period is different from the participation grade for the second period, the service providing apparatus 100 generates a command for changing display attributes of the object based on the participation grade for the second period and transmits the command to the user terminal 200. When receiving the command for changing the display attributes of the object (operation S1503), the user terminal 200 may change the display attributes of the object and display the changed display attributes as in operation S1409. On the other hand, if the participation grade for the first period is not different from the participation grade for the second period, the user terminal 200 keeps the display attributes of the object of the first period.

FIG. 16 is a block diagram of a user terminal 200 according to an embodiment.

Referring to FIG. 16, the user terminal 200 is a computing device capable of communicating with the service providing apparatus 100 through a network such as the Internet or an intranet and may include a communication unit 210, an input unit 220, an output unit 230, a storage unit 240, and a control unit 250.

The communication unit 210 may support wired/wireless Internet communication or intranet communication of the user terminal 200 and exchange various pieces of information with the service providing apparatus 100. The communication unit 210 may receive various user interfaces from the service providing apparatus 100 and receive a participation grade determined by the service providing apparatus 100 and/or a command for changing display attributes. Further, the communication unit 210 transmits attendee content input by a user to the service providing apparatus 100 via the network.

The input unit 220 receives various data, commands, and/or information from the user. In particular, the input unit 220 may receive user inputs to be transmitted to the service providing apparatus 100. Here, the user inputs may include the attendee content. The input unit 220 may include any type of input medium well known in the art to which the inventive concept pertains. For example, the input unit 220 may include a camera for receiving the user's image or an image designated by the user. Alternatively, the input unit 220 may include a microphone for receiving the user's voice.

The output unit 230 notifies the user of various data, commands, and/or information. The output unit 230 may include a display module. The display module may display various data. In particular, the display module may display an object corresponding to the user terminal 200 on a first area of a GUI provided by the service providing apparatus 100 and may display conference content on a second area of the GUI.

The output unit 230 of the inventive concept may further include any type of output medium well known in the art. For example, the output unit 230 may be configured as a touch screen having a touch sensor. In this case, the output unit 230 may also function as the input unit 220.

The storage unit 240 stores various data, commands, and/or information. The storage unit 240 may store one or more applications for receiving a conference service or an instant messaging service according to an embodiment. In addition, the storage unit 240 may store various pieces of information received through the communication unit 210 and various pieces of information input through the input unit 220.

The storage unit 240 may temporarily or non-temporarily store data received from an external device or a server. The storage unit 240 may be a nonvolatile memory such as a ROM, an EPROM, an EEPROM or a flash memory, a hard disk, a removable disk, or any type of computer-readable recording medium well known in the art to which the inventive concept pertains.

The control unit 250 controls the overall operation of each component of the user terminal 200. The control unit 250 may include a CPU, an MPU, an MCU, or any type of processor well known in the art to which the inventive concept pertains. In addition, the control unit 250 may include a memory, for example, a RAM. In addition, the control unit 250 may store at least one application or program for executing a method according to an embodiment.

The control unit 250 may change display attributes of the object on the GUI according to the attendee content and various interactions input by the user. Specifically, in response to a user input, the control unit 250 may control the display attributes of the object on the GUI to be changed and displayed based on the participation grade determined by the service providing apparatus 100. For example, the control unit 250 may change at least one of the size, position, and shape of the displayed object and display the object accordingly.

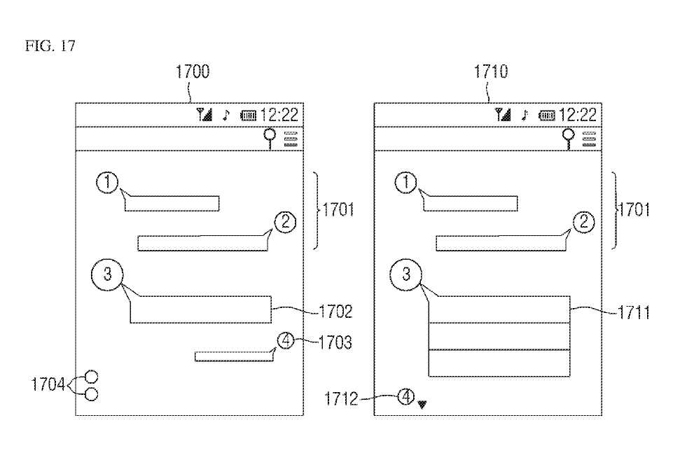

While a case where the service providing apparatus 100 provides a real-time conference service and where a user terminal 200 participates in the conference service and displays an object have been mainly described so far, embodiments of the inventive concept are not limited to this case. Hereinafter, a case where the service providing apparatus 100 provides an instant messaging service will be described with reference to FIG. 17.

FIG. 17 illustrates a method of displaying an object according to a participation grade in an instant messaging environment according to an embodiment.

It will hereinafter be assumed that an object includes not only a user avatar corresponding to a user terminal but also a message received from the user terminal.

Referring to FIG. 17, the service providing apparatus 100 may create an instant messaging session with user terminals 200. Here, the service providing apparatus 100 may provide a first GUI to the user terminals 200, with which the instant messaging session was created, for a first preset period. Here, the first GUI is a GUI in which participation grades of the user terminals 200 have not been reflected.

During the first period, the service providing apparatus 100 may determine participation grades of the user terminals 200 based on at least one of the size and the number of messages received through the first GUI. In addition, the service providing apparatus 100 may generate a second GUI, in which display attributes of objects corresponding to the user terminals 200 have been changed, based on the determined participation grades. Here, the second GUI is a GUI that reflects the degrees of participation of the user terminals 200. The display attributes of an object may include at least one of the display position and size of the object.

The service providing apparatus 100 may provide the generated second GUI to the user terminals 200 maintaining the instant messaging session for a second preset period.

On a service screen 1700, it is assumed that participation grades of object 1 and object 2 (1701) determined based on messages received for the first period are intermediate grades. The service providing apparatus 100 may enlarge an object of a user terminal having a high participation grade and display the enlarged object as in the case of object 3 (1702). On the other hand, the service providing apparatus 100 may reduce the size of an object of a user terminal having a low participation grade and display the reduced object as in the case of object 4 (1703).

The service screen 1700 may also include objects 1704 of user terminals which have not created a session or have terminated the session.

According to an embodiment, the service providing apparatus 100 may generate a second GUI that combines a plurality of messages received from any one of the user terminals 200 maintaining the instant messaging session and displays the combined messages. Referring to a service screen 1710, the service providing apparatus 100 may generate a message set by combining messages received from a user terminal having a high participation grade as in the case of object 3 (1711).

Accordingly, users of user terminals using the instant messaging service can easily grasp the main flow of conversation by checking the messages received from the user terminal having a high participation grade through the message set 1711.

On the other hand, the service providing apparatus 100 may apply a hiding function to messages received from a user terminal having a low participation grade as in the case of object 4 (1712). In this case, the users of the user terminals using the instant messaging service can selectively check the messages received from the user terminal having the low participation grade.

According to the inventive concept, an online attendee is provided with a GUI according to an embodiment. Therefore, the online attendee can have the same experience as attending an offline conference.

In addition, according to the inventive concept, the participation of an online attendee in a real-time conference can be increased by setting rights of the online attendee.

In addition, according to the inventive concept, the immersion of an online attendee in a real-time conference is increased, thereby improving the efficiency of the conference.

Further, according to the inventive concept, the topic of conversation can be promptly grasped in an interactive service environment.

The concepts of the invention described above can be embodied as computer-readable code on a computer-readable medium. The computer-readable medium may be, for example, a removable recording medium (a CD, a DVD, a Blu-ray disc, a USB storage device, or a removable hard disc) or a fixed recording medium (a ROM, a RAM, or a computer-embedded hard disc). The computer program recorded on the computer-readable recording medium may be transmitted to another computing apparatus via a network such as the Internet and installed in the computing apparatus. Hence, the computer program can be used in the computing apparatus.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A service providing method performed by a service providing apparatus, the method comprising:
creating a conference session with a plurality of user terminals;
generating a graphic user interface (GUI) that displays an object corresponding to each user terminal of the plurality of user terminals in a first area and displays conference content in a second area; and
providing the generated GUI to each user terminal maintaining the conference session;
wherein display attributes of the object are changed based on a conference participation grade of a corresponding user terminal.

2. The method of claim 1, wherein the generating of the GUI comprises generating a GUI in which at least one display attribute selected from an object position in the first area and an object size has been determined based on a number of the user terminals with which the conference session was created.

3. The method of claim 1, wherein the generating of the GUI comprises generating a GUI in which a plurality of objects are arranged along a preset path in the first area centered on a center point of the second area.

4. The method of claim 1, wherein the generating of the GUI comprises:
receiving voice content from a first user terminal among the user terminals with which the conference session was created; and
generating a GUI in which an object corresponding to the first user terminal from which the voice content is received is displayed in a preset shape.

5. The method of claim 1, wherein the generating of the GUI comprises:
receiving voice content from a first user terminal among user terminals with which the conference session was created;
receiving image content corresponding to a user from the first user terminal; and
displaying the received image content in a third area.

6. The method of claim 1, wherein the creating of the conference session with the plurality of user terminals comprises transmitting a conference session creation request to a preset number of user terminals and creating a conference session with the user terminals that have responded to the conference session creation request, and the generating of the GUI comprises generating a GUI in which an object corresponding to a user terminal that has not responded to the conference session creation request is displayed at a preset position in the first area.

7. The method of claim 1, wherein the generating of the GUI comprises:
detecting a change in a number of user terminal maintaining the conference session; and
generating a GUI in which at least one from among a position of the object in the first area and a size of the object has been changed based on the changed number of the user terminal.

8. The method of claim 1, wherein the generating of the GUI comprises determining a first participation grade of a first user terminal among the user terminals based on first conference attendee content received from the first user terminal, and the providing of the generated GUI to the each user terminal maintaining the conference session comprises determining a second participation grade of the first user terminal based on second conference attendee content received from the first user terminal, changing the display attributes of the object corresponding to the first user terminal in the first area when the first participation grade and the second participation grade of the first user terminal are different, and providing a GUI that displays the changed display attributes of the object to each user terminal.

9. The method of claim 1, further comprising:
receiving attendee content from each user terminal maintaining the conference session;
determining a conference participation grade of each user terminal based on at least one from among a number of times the attendee content was received and a data size of the received attendee content; and
changing the display attributes of the object corresponding to each terminal on the GUI based on the determined conference participation grade.

10. The method of claim 9, wherein the changing of the display attributes comprises changing at least one from among a shape, a color and a display brightness of the object based on the determined conference participation grade and displaying the object accordingly.

11. The method of claim 9, wherein the changing of the display attributes comprises:
comparing a conference participation grade determined for a first user terminal among the user terminals and a conference participation grade determined for a second user terminal among the user terminals; and
changing at least one from among a display size of an object corresponding to the first user terminal and a display size of an object corresponding to the second user terminal based on the comparing.

12. The method of claim 9, wherein the changing of the display attributes comprises:
comparing a conference participation grade determined for a first user terminal among the plurality of user terminals and a conference participation grade determined for a second user terminal among the plurality of user terminals; and
changing at least one from among a display position of an object corresponding to the first user terminal and a display position of an object corresponding to the second user terminal based on the comparing.

13. The method of claim 12, wherein the changing of the at least one from among the display position of the object corresponding to the first user terminal and the display position of the object corresponding to the second user terminal comprises placing a user terminal having a high conference participation grade closer to a center point of the second area than a user terminal having a low conference participation grade, or placing the user terminal having the low conference participation grade farther from the center point of the second area than the user terminal having the high conference participation grade.

14. The method of claim 9, wherein the determining the conference participation grade of each user terminal comprises:
identifying a type of the attendee content;
assigning a preset weight to the identified type of the attendee content; and
determining the conference participation grade based on the preset weight assigned to the identified type of the attendee content.

15. The method of claim 1, further comprising:
receiving attendee content from each user terminal maintaining the conference session;
determining a conference participation grade of each user terminal based on at least one from among a number of times the attendee content was received and a data size of the received attendee content; and
determining an access right of each user terminal to a menu on the GUI based on the determined conference participation grade.

16. A service providing method performed by a service providing apparatus, the method comprising:
creating an instant messaging session with a plurality of user terminals;
providing a first GUI to the plurality of user terminals with which the instant messaging session was created, for a first preset period;
determining a participation grade of each user terminal based on at least from among a size and a number of messages received through the first GUI for the first period;
generating a second GUI, in which display attributes of an object corresponding to each user terminal have been changed, based on the determined participation grade; and
providing the generated second GUI to each user terminal maintaining the instant messaging session for a second preset period.

17. The method of claim 16, wherein the display attributes of the object comprise at least one from among a display position of the object and a size of the object.

18. An object displaying method performed by a user terminal, the method comprising:
creating a conference session with a service providing apparatus;
receiving a GUI from the service providing apparatus, which displays an object corresponding to a user terminal in a first area and conference content in a second area;
receiving conference attendee content from a user, and
changing display attributes of the object in the first area based on a participation grade determined by the service providing apparatus in response to the receiving of the conference attendee content, and displaying the changed display attributes.

19. The method of claim 18, wherein the changing of the display attributes of the object in the first area based on the participation grade determined by the service providing apparatus and the displaying of the changed display attributes comprises:
receiving a command for changing the display attributes of the object from the service providing apparatus; and
changing at least one from among a shape, a color, a display position and a display size of the object in the first area in response to the received command.

20. The method of claim 18, further comprising:
receiving additional conference attendee content; and
when the participation grade is changed by the service providing apparatus in response to the receiving the additional conference attendee content, changing the display attributes of the object in the first area based on the changed participation grade, and displaying the changed display attributes.
